(19) United States
(12) Patent Application Publication
(10) Pub. No.: US 2026/0328038 A1
(43) Pub. Date: Oct. 22, 2026

(54) SYSTEMS AND METHODS FOR CONTROLLING TAILGATE MOVEMENT

(71) Applicant: Ford Global Technologies, LLC, Dearborn, MI (US)

(72) Inventors: Keith Weston, Canton, MI (US); Todd Ansbacher, Westland, MI (US); Stuart C. Salter, White Lake, MI (US); Vyas Darshan Shenoy, Canton, MI (US)

(73) Assignee: Ford Global Technologies, LLC, Dearborn, MI (US)

(21) Appl. No.: 19/182,910

(22) Filed: Apr. 18, 2025

(51) Int. Cl. E05F 15/43

(52) U.S. Cl. CPC E05F 15/43; E05F 2015/432; E05F 2015/434; E05Y 2400/822; E05Y 2900/544

(57) ABSTRACT

A vehicle having an electric outlet, vehicle sensor, and a tailgate is disclosed. The electric outlet may be located in a vehicle cargo compartment. The vehicle sensor may detect a presence or an absence of an electrical cord interfaced with the electric outlet. The tailgate may move between an open position and a closed position. The vehicle may include a processor that may obtain a trigger signal from a vehicle operator to move the tailgate from the open position to the closed position. Responsive to obtaining the trigger signal, the processor may predict that the electrical cord is expected to contact the tailgate during a tailgate closure operation based on inputs obtained from the vehicle sensor. Responsive to such prediction, the processor may perform a predetermined action.

### FIELD

The present disclosure relates to vehicles and more particularly to systems and methods for controlling tailgate movement in vehicles.

### BACKGROUND

A vehicle user may move a vehicle tailgate between a closed position and an open position. For example, the user may move the tailgate to the open position when the user requires access to the vehicle bed/compartment. The vehicle user may further move the tailgate to the closed position when the user may be driving the vehicle and/or may not require access to the vehicle bed/compartment.

The user may move the tailgate between the open and closed positions by manually moving the tailgate or via automatic means. The automatic means may include, for example, actuating a dedicated button/actuator on the tailgate or a vehicle interior portion or transmitting a tailgate movement command to the vehicle via a user device, a vehicle Human-Machine Interface (HMI), a key fob, and/or the like.

The vehicle may further have external power systems (or on-board power) to power auxiliary accessories, such as compressors, saws, electronic devices, etc. The vehicle power system may include electrical outlets that may enable the supply of power from the vehicle's battery to the external accessories. The electrical outlets may be disposed in a vehicle cargo compartment (e.g., in proximity to the tailgate). In some cases, electrical cords that interface with the electrical outlets may interfere with or contact the tailgate during the tailgate's closure operation.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example system to control tailgate movement in accordance with the present disclosure.

FIG. 3 depicts exemplary actions performed by a vehicle in accordance with the present disclosure.

FIG. 4 depicts a flow diagram of an example method to control tailgate movement in accordance with the present disclosure.

### DETAILED DESCRIPTION

### Overview

The present disclosure describes a system and method to control movement of a vehicle tailgate. The tailgate may move between an open position and a closed position when a user requests a tailgate movement. The system may control the tailgate movement such that the tailgate may not impede or impair any other component, such as electrical cords (described below), during the tailgate movement or the tailgate closure operation (e.g., when the tailgate moves from the open position to the closed position).

In some aspects, the vehicle may include a vehicle power system that may transfer power from a vehicle battery to an external accessory (e.g., a power tool, a lighting device, a motor, a saw, and/or the like). The vehicle power system may include electrical outlets (or any type of hardwired connection) that may enable the supply of power from the battery to the external accessory. The electrical outlets may be disposed in a vehicle cargo compartment (e.g., in proximity to a vehicle cargo bed or a vehicle tailgate). The electric outlet may enable the flow of electricity from the battery to the external accessory when the external accessory is connected to the electric outlet via one or more electrical cords (or cables).

As described above, the system may manage/control the tailgate operation to prevent impairment of the electrical cords during the tailgate closure operation. To perform its operation, the system may first obtain a trigger signal when the user desires to move the tailgate from the open position to the closed position. In an exemplary aspect, the system may obtain the trigger signal via a user device, a key fob, an infotainment system, a predefined user gesture or audio command or a predefined user movement pattern in proximity to the vehicle (e.g., when the tail gate is a powered tailgate). Alternatively, the system may obtain the trigger signal when the user manually moves the tailgate (e.g., when the tailgate is a non-powered tailgate).

Responsive to obtaining the trigger signal, the system may determine whether it is acceptable to close the tailgate either automatically or manually. In some aspects, to determine whether it is acceptable to close the tailgate, the system may obtain inputs from a vehicle sensor that indicates a presence or an absence of an electrical cord interfaced with the electric outlet. The vehicle sensor may be a vehicle camera (e.g., RGB camera, thermal/infrared camera, etc.). Based on the obtained inputs/images, the system may determine whether the electrical cords are connected to or disconnected from the electric outlet.

In some aspects, before obtaining the inputs from the vehicle sensor, the system may determine whether the vehicle power system (e.g., the electric outlet) is currently being used or was used recently (e.g., used less than a threshold time duration in the past). To make this determination, the system may obtain information associated with the current drawn by the electric outlet (e.g., by using sensors associated with the vehicle power system) to provide power to the external accessory. Based on the current draw information, the system may determine whether the electric outlet is currently being used or the electric outlet was used recently (e.g., used 2 minutes ago). Responsive to a determination that the electric outlet is currently being used or the electric outlet was used recently, the system may obtain inputs (e.g., images) from the vehicle sensor and determine whether the electrical cords are connected to or disconnected from the electric outlet based on the obtained inputs/images.

In further aspects, based on the inputs obtained from the vehicle sensor, the system may predict that the electrical cord is expected to contact the tailgate during the tailgate closure operation. For instance, when the external accessory is positioned on the ground or anywhere outside the vehicle and the electrical cords connect the electric outlet with the external accessory (as determined via the images captured from the vehicle's cameras), the system may predict that the electrical cords may interfere/contact with the tailgate during the tailgate closure operation, which may cause electrical cords' impairment. The system may perform a predetermined action based on the prediction to prevent such a scenario from occurring.

For instance, the system may output an alert notification via the user device, a vehicle Human-Machine Interface (HMI), a vehicle speaker, one or more vehicle lights, etc. indicating to the user that the tailgate should not be moved as the electrical cords are connected to the electric outlet and may contact/interfere with the tailgate during the tailgate closure operation. In further aspects, the system may deactivate the tailgate actuator to prevent the tailgate from moving to the closed position or may reverse the tailgate movement to move the tailgate from its current position to the open position (e.g., if the user is manually closing the tailgate). In this manner, the system prevents the cords from getting impaired.

The present disclosure discloses a system and method that ensures that the tailgate is moved in an optimal manner, while at the same time ensuring that the electrical cords are not impaired. The system may determine the presence of the electrical cords near the tailgate and perform remedial actions to prevent cord's impairment during the tailgate movement. In addition, the system uses vehicle's existing components to move the tailgate in an optimal manner and prevent cord's impairment.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

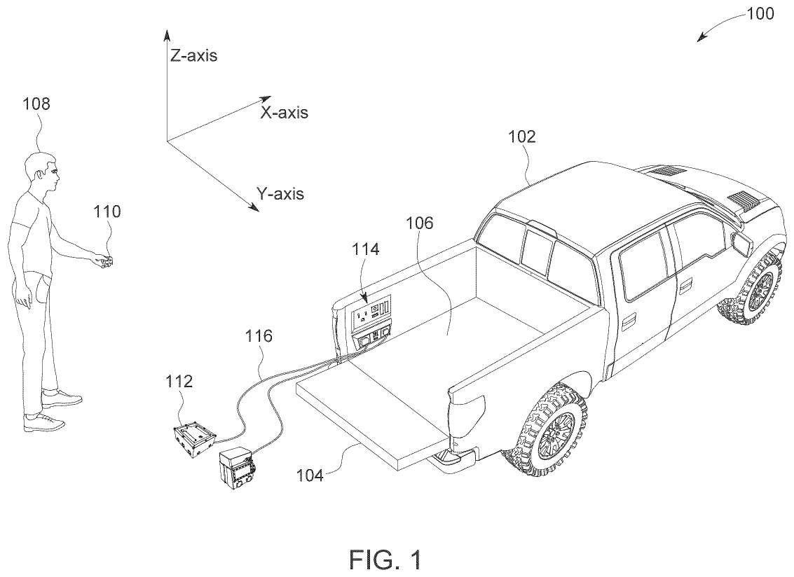

FIG. 1 depicts an example environment 100 in which techniques and structures for providing the systems and methods disclosed herein may be implemented. The environment 100 may include a vehicle 102 that includes a tailgate 104 and a vehicle bed 106. The vehicle 102 may take the form of any passenger or commercial vehicle such as a car, a work vehicle, a crossover vehicle, a truck, a van, a minivan, a taxi, a bus, etc. The vehicle 102 may be a manually driven vehicle or may be configured to operate in a partially/fully autonomous mode and may include any powertrain such as a gasoline engine, one or more electrically-actuated motor(s), a hybrid system, etc.

The tailgate 104 may be disposed at a vehicle rear portion and may be configured to move between an open position (as shown in FIG. 1) and a closed position. In some aspects, the tailgate 104 may be in the closed position when a tailgate plane may be perpendicular to a vehicle bed plane and in the open position when the tailgate plane may be parallel to the vehicle bed plane. For example, as shown in FIG. 1, the tailgate plane and the vehicle bed plane are in the X-Y plane when the tailgate 104 is in the open position.

In some aspects, a user 108 may cause a tailgate movement between the closed position and the open position by manually moving the tailgate 104. The user 108 may move the tailgate 104 to the open position when the user 108 requires access to the vehicle bed 106 (e.g., to load or unload one or more items that may be placed on the vehicle bed 106). Further, the user 108 may move the tailgate 104 to the closed position when the user 108 requires driving the vehicle 102 and/or when the user 108 may not require access to the vehicle bed 106.

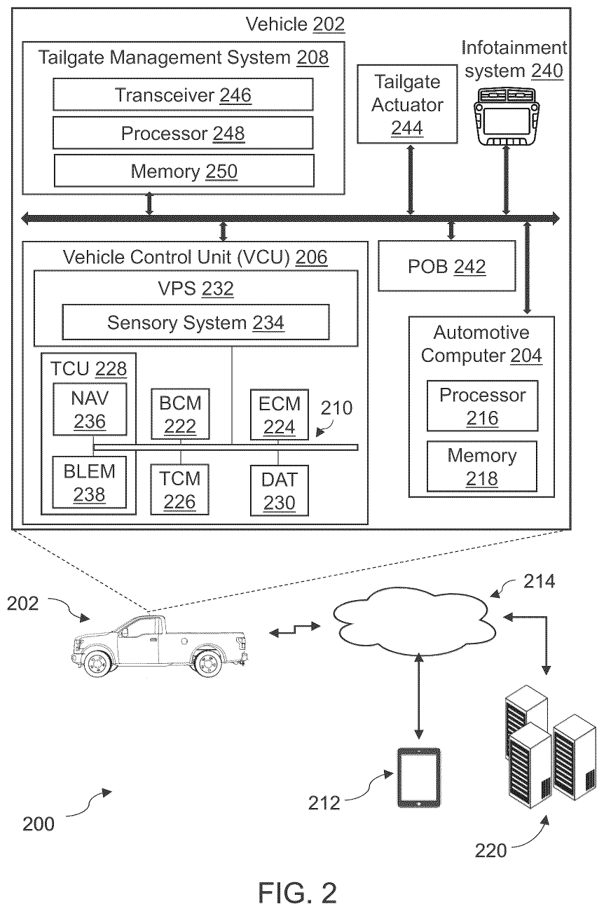

In other aspects, the user 108 may cause the tailgate movement between the closed position and the open position via automated means. For example, the user 108 may move the tailgate 104 to the closed position from the open position (or vice-versa) by pressing/actuating a dedicated tailgate button that may be disposed on the tailgate 104 or a vehicle interior portion. Responsive to the user 108 pressing the button, the vehicle 102 may initiate a tailgate movement process to cause the tailgate movement from the open position to the closed position (or vice-versa). In additional aspects, the user 108 may move the tailgate 104 to the closed position from the open position (or vice-versa) by wirelessly transmitting a tailgate movement command to the vehicle 102 via a user device (shown as user device 212 in FIG. 2), a vehicle Human-Machine Interface (HMI)/infotainment system or a key fob 110. The vehicle 102 may initiate the tailgate movement process responsive to receiving the tailgate movement command from the user device, the infotainment system, or the key fob 110. For instance, the vehicle 102 may wirelessly activate a tailgate actuator (or motor) that enables the tailgate 104 to move between the open position and the closed position.

The vehicle 102 may further include a vehicle power system (shown as power on-board (POB) 242 in FIG. 2) that may provide/supply power to an external accessory 112. In some aspects, the vehicle power system may transfer power from a vehicle's battery to the external accessory 112. The battery may be disposed in the vehicle 102. The external accessory 112 may be, for example, a plasma cutter, a TiG welder, a chop saw, an air compressor, an angle grinder, a jackhammer, a projector, loudspeakers, lighting devices, cement mixers, a mini fridge, and/or the like.

The vehicle power system may include one or more electrical outlets 114 or any type of hardwired connection, such as a fixed hardwired connection, between the vehicle power system and the external accessory 112. In some aspects, the electric outlet 114 may be disposed in a vehicle cargo compartment (e.g., in proximity to the vehicle bed 106 or the tailgate 104, as depicted in FIG. 1). The electric outlet 114 may enable the flow of electricity from the battery to the external accessory 112 when the external accessory 112 is connected to the electric outlet 114 via one or more electrical cords 116 (or cables).

It may be appreciated that if the user 108 moves the tailgate 104 from the open position to the closed position and the external accessory 112 (which may be positioned on the ground or any other position) is still connected to the electric outlet 114 via the electrical cords 116, the electrical cords 116 may get impaired by the moving tailgate 104. Stated another way, when the electrical cords 116 are connected to the electric outlet 114 and the tailgate 104 is moved, the electrical cords 116 may interfere/contact with the tailgate 104 during the tailgate closure operation (e.g., when the tailgate 104 moves from the open position to the closed position), which may impair the electrical cords 116 and may also interrupt the tailgate closure operation. The vehicle 102, as described in the present disclosure, may prevent such a scenario from occurring, as described briefly below and described in detail later in conjunction with FIG. 2.

In some aspects, the vehicle 102 may further include a vehicle sensor (or sensor suite) that may detect a presence or an absence of the electrical cords 116 interfaced with the electric outlet 114. Stated another way, the vehicle sensor may detect whether the electrical cords 116 are connected to or disconnected from the electric outlet 114.

The vehicle 102 may further include a tailgate management system (shown as tailgate management system 208 in FIG. 2) that may manage/control the tailgate operation to prevent impairment of the electrical cords 116 during the tailgate closure operation. To perform its operation, the tailgate management system (or system) may first obtain a trigger signal from the user 108 (e.g., via the user device, the key fob 110, the HMI, the dedicated tailgate button, etc. or when the user 108 manually pushes the tailgate 104) to move the tailgate 104 from the open position to the closed position. Responsive to obtaining the trigger signal, the system may determine whether it is acceptable to close the tailgate 104 either automatically or manually. In some aspects, to determine whether it is acceptable to close the tailgate 104, the system may determine whether the vehicle power system (e.g., the electric outlet 114) is currently being used or was used recently (e.g., used less than a threshold time duration in the past). To make this determination, the system may obtain information associated with the current drawn by the electric outlet 114 (e.g., by using the sensors associated with the vehicle power system) to provide power to the external accessory 112. Based on the current draw information, the system may determine whether the electric outlet 114 is currently being used or the electric outlet 114 was used recently (e.g., used 2 minutes ago).

Responsive to a determination that the electric outlet 114 is currently being used or the electric outlet 114 was used recently, the system may obtain inputs (e.g., images) from the vehicle sensor (e.g., camera) and determine whether the electrical cords 116 are connected to or disconnected from the electric outlet 114 based on the obtained inputs/images. When the electric outlet 114 is currently being used or the electric outlet 114 was used recently, the probability of the electrical cords 116 being still connected to the electric outlet 114 is high. In this case, the system may obtain inputs from the vehicle sensor to confirm whether the electrical cords 116 are connected to the electric outlet 114 or not. In alternative aspects, the system may obtain the inputs from the vehicle sensor without determining whether the electric outlet 114 is currently being used or was used recently. Stated another way, in some aspects, the system may skip the step of determining whether the electric outlet 114 is currently being used or was used recently. In this case, the system may obtain the inputs from the vehicle sensor directly after obtaining the trigger signal from the user 108.

Responsive to obtaining the inputs from the vehicle sensor, the system may predict whether the electrical cords 116 are expected to contact/interfere with the tailgate 104 during the tailgate closure operation based on the inputs obtained from the vehicle sensor. For instance, when the external accessory 112 is positioned on the ground or anywhere outside the vehicle 102 and the electrical cords 116 connect the electric outlet 114 with the external accessory 112 (as determined via the images captured from the vehicle's cameras), the system may predict that the electrical cords 116 may interfere/contact with the tailgate 104 during the tailgate closure operation, which may cause electrical cords impairment. In this case, the system may execute a Machine Learning (ML) model to predict the position of the electrical cords 116 as the tailgate 104 moves from the open position to the closed position when the electrical cords 116 are connected to the electric outlet 114. Based on the output of the ML model, the system may determine or predict whether the electrical cords 116 would interfere with the tailgate movement when the tailgate 104 moves. Based on a determination that the electrical cords 116 are connected to the electric outlet 114 and the prediction that the electrical cords 116 may contact or interfere with the tailgate 104 during the tailgate closure operation, the system may perform a predetermined action or a remedial action to prevent such a scenario from occurring.

For instance, the system may output an alert notification via the user device, a vehicle Human-Machine Interface (HMI), a vehicle speaker, one or more vehicle lights, etc., indicating to the user 108 that the tailgate 104 should not be moved as the electrical cords 116 are connected to the electric outlet 114 and may contact/interfere with the tailgate 104 during the tailgate closure operation. In further aspects, the system may deactivate the tailgate actuator to prevent the tailgate 104 to move from the open position to the closed position, or may reverse the tailgate movement to move the tailgate 104 from its current position to the open position (e.g., if the user 108 is manually closing the tailgate 104). In this manner, the vehicle 102 may facilitate in ensuring that the tailgate 104 is moved in an optimal manner, while at the same time ensuring that the electrical cords 116 are not impaired. Further vehicle 102 details are described below in conjunction with FIG. 2.

The vehicle 102 implements and/or performs operations, as described here in the present disclosure, in accordance with the owner manual and safety guidelines. In addition, any action taken by the vehicle operator based on the notifications provided by the vehicle 102 should comply with all the rules specific to the location and operation of the vehicle 102 (e.g., Federal, state, country, city, etc.). The notifications, as provided by the vehicle 102, should be treated as suggestions and only followed according to any rules specific to the location and operation of the vehicle 102.

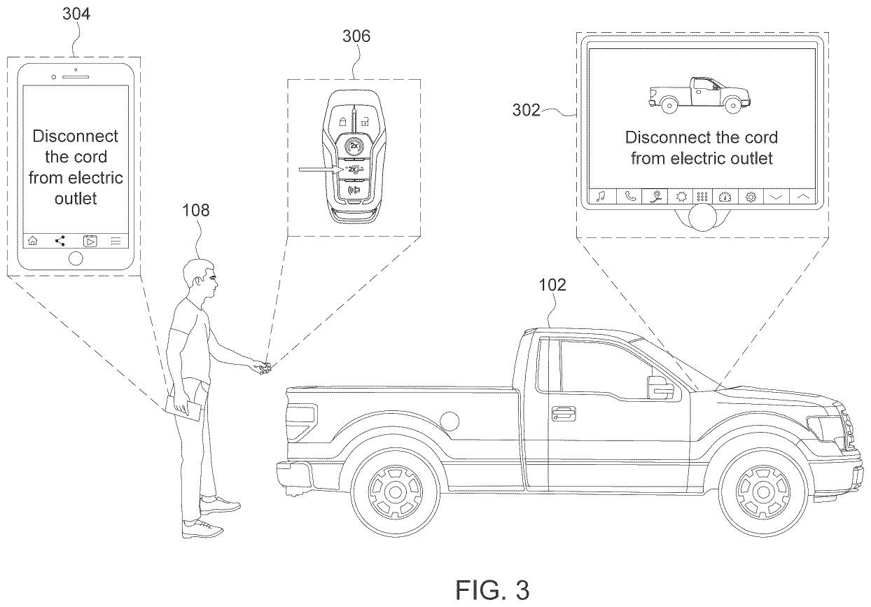

FIG. 2 depicts a block diagram of an example system 200 to control tailgate movement in accordance with the present disclosure. While describing FIG. 2, references may be made to FIG. 3.

The system 200 may include a vehicle 202, which may be the same as the vehicle 102 described above in conjunction with FIG. 1. The vehicle 202 may include an automotive computer 204, a Vehicle Control Unit (VCU) 206 and a tailgate management system 208. The VCU 206 may include a plurality of Electronic Control Units (ECUs) 210 disposed in communication with the automotive computer 204.

The system 200 may further include a user device 212 that may connect with the automotive computer 204 and/or the tailgate management system 208 by using wired and/or wireless communication protocols and transceivers. The user device 212 may be associated with the user 108 and may be, for example, a mobile phone, a computer, a laptop, a tablet, a smart wearable device, or any other device with communication capabilities. The user device 212 may communicatively couple with the vehicle 202 via one or more network(s) 214.

The network(s) 214 illustrates an example communication infrastructure in which the connected devices discussed in various embodiments of this disclosure may communicate. The network(s) 214 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In some aspects, the automotive computer 204 and/or the tailgate management system 208 may be installed anywhere in the vehicle 202, in accordance with the disclosure. Further, the automotive computer 204 may operate as a functional part of the tailgate management system 208. The automotive computer 204 may be or include an electronic vehicle controller, having one or more processor(s) 216 and a memory 218. Moreover, the tailgate management system 208 may be separate from the automotive computer 204 (as shown in FIG. 2) or may be integrated as part of the automotive computer 204.

The processor(s) 216 may be disposed in communication with one or more memory devices disposed in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable medium or memory storing a vehicle tailgate management program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the automotive computer 204 and/or the tailgate management system 208 may be disposed in communication with one or more server(s) 220 and the user device 212 via the network 214. In some aspects, the server(s) 220 may be part of a cloud-based computing infrastructure and may be associated with and/or include a Telematics Service Delivery Network (SDN) that provides digital data services to the vehicle 202 and other vehicles (not shown in FIG. 2) that may be part of a vehicle fleet. In further aspects, the server 220 may store real-time information associated with the electric outlet 114 (e.g., current drawn by the electric outlet 114) and may transmit this information to the vehicle 202 (or the user device 212) at a predefined frequency or when the vehicle 202 (or the user device 212) transmits a request to the server 220 to obtain such information.

In accordance with some aspects, the VCU 206 may share a power bus with the automotive computer 204 and may be configured and/or programmed to coordinate the data between vehicle 202 systems, connected servers (e.g., the server(s) 220), and other vehicles (not shown in FIG. 2) operating as part of a vehicle fleet. The VCU 206 may include or communicate with any combination of the ECUs 210, such as a Body Control Module (BCM) 222, an Engine Control Module (ECM) 224, a Transmission Control Module (TCM) 226, a telematics control unit (TCU) 228, a Driver Assistances Technologies (DAT) controller 230, etc.

The VCU 206 may further include and/or communicate with a Vehicle Perception System (VPS) 232, having connectivity with and/or control of one or more vehicle sensory system(s) 234. The vehicle sensory system 234 may include one or more vehicle sensors including, but not limited to, a radio detection and ranging (radar) sensor configured for detection and localization of objects inside and outside the vehicle 202 using radio waves, sitting area buckle sensors, sitting area sensors, a light detecting and ranging (lidar) sensor, door sensors, proximity sensors, temperature sensors, wheel sensors, ambient weather sensors, vehicle internal and external cameras, vehicle external power usage sensors, one or more rain sensors, capacitive moisture sensors, microphones, etc.

In some aspects, the vehicle sensory system 234 may be configured to capture inputs associated with the tailgate 104, electric outlet 114, the electrical cords 116, and/or the like. For example, the vehicle sensory system 234 may capture one or more tailgate images via the vehicle's interior or exterior cameras (or RGB cameras), one or more radar sensors, lidar sensors, thermal/infrared cameras (that detects/captures infrared (IR) radiation (heat) emitted by objects, such as the electrical cords 116, and converts it into a visual image), and/or the like. In some aspects, the vehicle external power usage sensors may be associated with the vehicle power system and may detect an actual vehicle power system usage such as an actual amount of energy (current/power) that may be getting drawn from the vehicle power system (or the electric outlet 114), a time duration for which the energy may be drawn, a rate at which the energy may be drawn, etc.

In some aspects, the VCU 206 may control the vehicle 202 operational aspects and implement one or more instruction sets received from the user device 212, from one or more instruction sets stored in the memory 218, including operation instructions as part of the tailgate management system 208.

The TCU 228 may be configured and/or programmed to provide vehicle connectivity to wireless computing systems onboard and off board the vehicle 202, and may include a Navigation (NAV) receiver 236 for receiving and processing a GPS signal, a BLE® Module (BLEM) 238, a Wi-Fi transceiver, a UWB transceiver, and/or other wireless transceivers (not shown in FIG. 2) that may be configurable for wireless communication (including cellular communication) between the vehicle 202 and other systems (e.g., the user device 212, the key fob 110, etc.), computers, and modules. The TCU 228 may be disposed in communication with the ECUs 210 by way of a bus.

The ECUs 210 may control aspects of vehicle operation and communication using inputs from human drivers, inputs from an autonomous vehicle controller, the tailgate management system 208, and/or via wireless signal inputs received via the wireless connection(s) from other connected devices, such as the user device 212, the server(s) 220, among others.

The BCM 222 generally includes integration of sensors, vehicle performance indicators, and variable reactors associated with vehicle systems and may include processor-based power distribution circuitry that can control functions associated with the vehicle body such as lights, windows, security, camera(s), audio system(s), speakers, door locks and access control (including vehicle power system control), a tailgate actuator (shown as tailgate actuator 244 in FIG. 2), and various comfort controls. The BCM 222 may also operate as a gateway for bus and network interfaces to interact with remote ECUs (not shown in FIG. 2).

The DAT controller 230 may provide Level-1 through Level-3 automated driving and driver assistance functionality that can include, for example, active parking assistance, vehicle backup assistance, and/or adaptive cruise control, among other features. The DAT controller 230 may also provide aspects of user and environmental inputs usable for user authentication.

In some aspects, the automotive computer 204 may connect with an infotainment system 240 that may include a touchscreen interface portion and may include voice recognition features, biometric identification capabilities that can identify users based on facial recognition, voice recognition, fingerprint identification, or other biological identification means. In other aspects, the infotainment system 240 may be further configured to receive user instructions via the touchscreen interface portion, and/or display notifications, navigation maps, etc. on the touchscreen interface portion. The vehicle 202 may further include speakers/sound exciters (not shown) to provide notifications to the user 108.

The computing system architecture of the automotive computer 204, the VCU 206, and/or the tailgate management system 208 may omit certain computing modules. It should be readily understood that the computing environment depicted in FIG. 2 is an example of a possible implementation according to the present disclosure, and thus, it should not be considered limiting or exclusive.

The vehicle 202 may further include a battery configured to store power. The vehicle 202 may additionally include a vehicle power system (shown as POB 242 in FIG. 2) that may transfer power from the battery to the external accessory 112. In some aspects, the vehicle power system may include an inverter and an electric motor (not shown) that may be powered by the battery. The vehicle power system may further include one or more electrical components. For instance, the vehicle power system may include a circuit breaker that may stop the flow of current from the vehicle power system when the vehicle power system outputs current/power, via the electric outlet 114, that is greater than a threshold value. The vehicle power system may further include fuse, circuit, and other electrical components.

The vehicle 202 may further include the tailgate actuator 244 (e.g., a tailgate motor) that may move the tailgate 104 automatically between the open position and the closed position. The tailgate management system 208 may activate or deactivate the tailgate actuator 244 to move the tailgate 104 between the open position and the closed position, based on user inputs (as described below).

In accordance with some aspects, the tailgate management system 208 may be integrated with and/or executed as part of the ECUs 210. The tailgate management system 208, regardless of whether it is integrated with the automotive computer 204 or the ECUs 210, or whether it operates as an independent computing system in the vehicle 202, may include a transceiver 246, a processor 248, and a computer-readable memory 250.

The transceiver 246 may receive information/inputs from one or more external devices or systems, e.g., the user device 212, the server(s) 220, and/or the like via the network 214. For example, the transceiver 246 may receive a user request and/or user inputs/instructions to move the tailgate 104 between the open position and the closed position. Further, the transceiver 246 may transmit notifications (e.g., alarm signals) or information to the external devices or systems such as the user device 212. In addition, the transceiver 246 may receive information/inputs from vehicle 202 components such as the infotainment system 240, the vehicle sensory system 234 (including inputs from the camera(s), vehicle external power usage sensors, etc.), and/or the like. Further, the transceiver 246 may transmit notifications (e.g., alarm signals) to the vehicle 202 components such as the infotainment system 240, speaker, etc.

The processor 248 and the memory 250 may be the same as or similar to the processor 216 and the memory 218, respectively. Specifically, the processor 248 may utilize the memory 250 to store programs in code and/or to store data for performing aspects in accordance with the disclosure. The memory 250 may be a non-transitory computer-readable memory storing the vehicle tailgate management program code.

In operation, the processor 248 may obtain a trigger signal from the user 108 to move the tailgate 104 from the open position to the closed position. When the tailgate 104 is a non-powered tailgate, the processor 248 may obtain the trigger signal when the user 108 manually moves the tailgate 104 from the open position to the closed position. In this case, the processor 248 may obtain the trigger signal from the vehicle's cameras that may capture the images of the tailgate 104 being moved by the user 108 (or any other tailgate position sensor located in the vehicle 202). On the other hand, when the tailgate 104 is a powered tailgate, the processor 248 may obtain the trigger signal to activate the tailgate actuator 244 to move the tailgate 104 from the open position to the closed position via the user device 212, the key fob 110, the infotainment system 240, a predefined user gesture or audio command or a predefined user movement pattern in proximity to the vehicle 102 (as detected by the vehicle sensory system 234/cameras), and/or the like. Alternatively, the processor 248 may obtain the trigger signal from the tailgate button when the user 108 presses the tailgate button located on the tailgate 104 or any other position in the vehicle interior portion.

Responsive to obtaining the trigger signal by any of the means described above, the processor 248 may determine whether it is acceptable to move the tailgate 104 from the open position to the closed position (e.g., without impairing the electrical cords 116 that may be connected to the electric outlet 114). To determine whether it is acceptable to move the tailgate 104 from the open position to the closed position, the processor 248 may first determine whether the electric outlet 114 is currently being used to power the external accessory 112 or the electric outlet 114 was used less than a threshold time duration in the past (e.g., the electric outlet 114 was in user 2-5 minutes ago). For instance, the processor 248 may obtain inputs associated with the current drawn by the electric outlet 114 from the vehicle external power usage sensors and determine whether the electric outlet 114 is currently being used or the electric outlet 114 was used recently. In some aspects, the inputs associated with the current drawn by the electric outlet 114 includes time stamps associated with current drawn by the electric outlet 114, which may enable the processor 248 to determine whether the electric outlet 114 is currently being used or the electric outlet 114 was used recently.

Responsive to determining that the electric outlet 114 is currently being used or the electric outlet 114 was used recently, the processor 248 may obtain inputs from the vehicle sensory system 234, e.g., the vehicle cameras, to check if the electrical cords 116 are connected to the electric outlet 114. As described above in conjunction with FIG. 1, in some aspects, the processor 248 may skip the step of determining whether the electric outlet 114 is currently being used or the electric outlet 114 was used recently and may directly obtain the inputs from the vehicle sensory system 234 to check if the electrical cords 116 are connected to the electric outlet 114, responsive to obtaining the trigger signal from the user 108. As may be appreciated, the probability of the electrical cords 116 being connected to the electric outlet 114 is high if the electric outlet 114 is currently being used or the electric outlet 114 was used recently. Therefore, in some aspects, the processor 248 performs the step of determining whether the electric outlet 114 is currently being used or the electric outlet 114 was used recently, before obtaining the inputs from the vehicle sensory system 234 to check if the electrical cords 116 are connected to the electric outlet 114. However, as described above, this step is not mandatory to be performed, and the processor 248 may skip this step, without departing from the scope of the present disclosure.

Based on the inputs obtained from the vehicle sensory system 234, the processor 248 may determine whether the electrical cords 116 are connected to or disconnected from the electric outlet 114 and predict that the electrical cords 116 may contact the tailgate 104 or interfere with the tailgate movement during tailgate closure operation based on the obtained inputs. For instance, the processor 248 may obtain inputs from the vehicle's RGB camera and/or the thermal/infrared camera and detect whether the electrical cords 116 are connected to the electric outlet 114 based on the inputs from the camera(s).

In addition, the processor 248 may predict (based on the inputs obtained from the camera(s) and the ML model described above in conjunction with FIG. 1) that the electrical cords 116 may interfere/contact with the tailgate 104 during the tailgate closure operation, which may cause electrical cords' impairment. For instance, when the external accessory 112 is positioned on the ground or anywhere outside the vehicle 102 and the electrical cords 116 connect the electric outlet 114 with the external accessory 112, the processor 248 may predict that the electrical cords 116 may interfere/contact with the tailgate 104 during the tailgate closure operation. In some aspects, the processor 248 may predict that the electrical cords 116 may contact the tailgate 104 during the tailgate closure operation based on a current position of the electrical cords 116 relative to the tailgate 104 (which may be determined by the processor 248 based on the inputs obtained from the camera(s)) and the expected trajectory of the tailgate movement during its closure operation. If the current position of the electrical cords 116 and the expected trajectory of the tailgate movement intersect, the processor 248 may predict that the electrical cords 116 contact the tailgate 104 or interfere with its movement during the tailgate closure operation. In another instance, when the processor 248 determines that the tailgate 104 was in the closed position when the power was initially drawn by the electric outlet 114 (based on the inputs obtained from the camera(s) and the vehicle external power usage sensors), the processor 248 may predict that the electrical cords 116 may not contact the tailgate 104 or not interfere with its movement.

Responsive to predicting that the electrical cords 116 may contact the tailgate 104 during the tailgate closure operation, the processor 248 may perform one or more predetermined actions or remedial actions that are described below. Some of the predetermined actions are illustrated in FIG. 3, which should not be construed as limiting.

In some aspects, to perform the predetermined or remedial action, the processor 248 may deactivate the tailgate actuator 244 to prevent the tailgate movement from the open position to the closed position. In some aspects, the processor 248 may disable the tailgate actuator 244 when the tailgate 104 is a powered tailgate. Disabling the tailgate actuator 244 may prevent the user 108 from moving the tailgate 104 from the open position to the closed position, thereby preventing the cords' impairment.

In further aspects, to perform the predetermined or remedial action, the processor 248 may provide an alert to the user 108 via the user device 212, a vehicle speaker, a vehicle light, or the infotainment system 240, prior to allowing/performing the tailgate closure operation. The alert may indicate that the electrical cords 116 may interfere/contact the tailgate 104 if the tailgate 104 is moved from the open position to the closed position. For instance, the processor 248 may illuminate/flash the vehicle light located at the vehicle rear portion (or any other portion) to indicate that the electrical cords 116 may interfere/contact with the tailgate 104 if the tailgate 104 is moved from the open position to the closed position. The processor 248 may illuminate the vehicle light in any pattern to provide the alert to the user 108. In further aspects, the processor 248 may activate the vehicle speaker to output chime, tones, words, etc., to provide alert to the user 108. Responsive to viewing or hearing the alert, the user 108 may remove the electrical cords 116, thereby preventing their impairment. In another instance, to provide the alert via the infotainment system 240, the processor 248 may output a notification (or a “first notification”) on the infotainment system 240. The first notification may include a request for the user 108 to disconnect the electrical cords 116 from the electric outlet 114, as shown in view 302 of FIG. 3. In addition, the processor 248 may output a second notification on the user device 212 to provide the alert to the user 108. The second notification may further request the user 108 to disconnect the electrical cords 116 from the electric outlet 114, as shown in view 304 of FIG. 3.

In further aspects, to perform the predetermined or remedial action, the processor 248 may require double activation/double press prior to allowing the tailgate closure operation. For instance, in this case, the processor 248 may require double activation/double press on the key fob 110 (or the user device 212, any vehicle component, etc.) to allow the tailgate closure operation (e.g., to allow the tailgate 104 to move from the open position to the closed position), as shown in a view 306 of FIG. 3. Double activation ensures that the tailgate 104 moves when the user 108 really wants to move the tailgate 104 and not when the button is pressed inadvertently. When the user 108 presses the key fob button twice, the processor 248 may activate the tailgate actuator 244 to move the tailgate 104 from the open position to the closed position. Specifically, in this case, the processor 248 may obtain a double trigger/activation signal from the user 108 (via the key fob 110, user device 212, the infotainment system 240) to activate the tailgate actuator 244 to move the tailgate 104 from the open position to the closed position and then activate the tailgate actuator 244 responsive to obtaining the double trigger signal.

In additional aspects, to perform the predetermined or remedial action, the processor 248 may determine that the tailgate 104 is moving from the open position to the closed position (e.g., when the tailgate closure operation is commanded such as by double pressing the key fob button or when the user 108 may be manually moving the tailgate 104 from the open position to the closed position). To determine that the tailgate 104 is moving from the open position to the closed position, the processor 248 may obtain inputs/images from the vehicle sensory system 234 (including the camera(s), other sensors associated with the tailgate 104) and determine that the tailgate 104 is moving from the open position to the closed position based on the obtained inputs.

Responsive to determining that the tailgate 104 is moving from the open position to the closed position, the processor 248 may monitor one or more electrical components associated with the electric outlet 114 or the electrical cords 116 via the inputs obtained from the sensors associated with the vehicle power system (e.g., the vehicle external power usage sensors), when the tailgate 104 is moving from the open position to the closed position. The electrical components may include, but are not limited to, circuit breakers, fuse, circuits, or any other electrical component. Based on the monitoring, the processor 248 may determine a sub-optimal condition associated with the electrical components when the tailgate 104 may be moving. For instance, the processor 248 may monitor the current drawn by the electric outlet 114 and may monitor any spike in the current drawn by the electric outlet 114 or any other unusual electrical activity when the tailgate 104 may be moving and may determine impairment of the electrical cords 116 based on the monitoring (e.g., when a spike in the current drawn is detected).

In addition or alternatively, responsive to determining that the tailgate 104 is moving from the open position to the closed position, the processor 248 may obtain inputs from the vehicle's microphone or sound exciters. The inputs may be audio signals associated with sparking, arcing, or distress tones associated with the electric outlet 114 or the electrical cords 116, when the tailgate 104 is moving from the open position to the closed position. Stated another way, the processor 248 may determine whether the electric outlet 114 and/or the electrical cords 116 is generating unusual sound based on the inputs from the vehicle microphone or sound exciters when the tailgate 104 is moving from the open position to the closed position, which may indicate impairment of the electrical cords 116.

Based on the sub-optimal condition determination and/or based on the inputs obtained from the vehicle microphone or sound exciters as described above, the processor 248 may stop the tailgate movement. For instance, the processor 248 may disable the tailgate actuator 244 to prevent the tailgate 104 from moving from its current position to the closed position (or disable the tailgate actuator 244 to continue the tailgate closure operation) when the sub-optimal condition or an unusual sound is detected, as described above. In further aspects, the processor 248 may reverse the tailgate movement from its current position to the open position based on the determination of the sub-optimal condition or based on the inputs obtained from the vehicle microphone or sound exciters. Stated another way, the processor 248 may reverse the direction of tailgate movement when the processor 248 detects any adverse situation that indicates the electrical cords' impairment. Therefore, in this case, instead of moving the tailgate 104 from the open position to the closed position, the processor 248 may move the tailgate 104 back to the open position to prevent the electrical cords' impairment. In further aspects, the processor 248 may provide an alert to the user 108 via the infotainment system 240, the speaker, the user device 212 (in the manner described above), based on the determination of the sub-optimal condition or based on the inputs obtained from the vehicle microphone or sound exciters. In this manner, the processor 248 may prevent impairment of the electrical cords 116 due to the tailgate closure operation, even when the tailgate 104 is moving from the open position to the closed position.

In additional or alternative aspects of the present disclosure, after obtaining the trigger signal from the user 108 to move the tailgate 104 from the open position to the closed position, the processor 248 may obtain inputs from the user 108 to determine whether the electrical cords 116 are connected to or disconnected from the electric outlet 114. In some aspects, to obtain the inputs from the user 108, the processor 248 may output a notification for the user 108 (via the infotainment system 240, the user device 212 etc.) to confirm absence of the electrical cords 116 prior to activating the tailgate actuator 244 (e.g., to move the tailgate 104 from the open position to the closed position). Responsive to outputting the notification, the processor 248 may obtain the confirmation from the user 108 and activate the tailgate actuator 244 to move the tailgate 104 from the open position and the closed position responsive to obtaining the confirmation. For instance, after obtaining the trigger signal, the processor 248 may obtain the confirmation from the user 108 that the electrical cords 116 are not connected to the electric outlet 114 and/or the electrical cords 116 may not interfere/contact the tailgate 104 during the tailgate closure operation. The processor 248 may obtain the confirmation from the infotainment system 240, the user device 212, voice command, and/or gesture-based input. The processor 248 may activate the tailgate actuator 244 to move the tailgate 104 from the open position and the closed position responsive to obtaining the confirmation. Stated another way, the processor 248 may allow the tailgate 104 to move the tailgate 104 from the open position to the closed position when the user 108 confirms that there is no electrical cord that is connected to the electric outlet 114 and the electrical cord may not interfere/contact the tailgate 104 during the tailgate closure operation. In some aspects, when the user 108 is using the user device 212 to provide the confirmation that there is no electrical cord that is connected to the electric outlet 114, the processor 248 may require/request a supplemental image from the user device 212 for the confirmation.

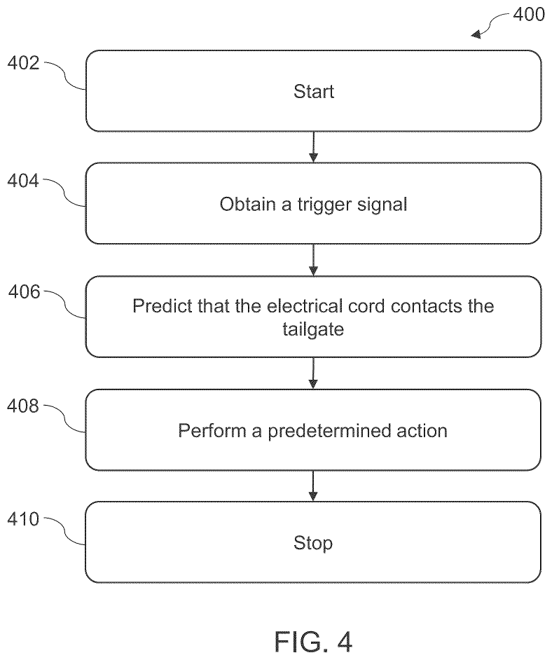

FIG. 4 depicts a flow diagram of an example method 400 to control tailgate movement in accordance with the present disclosure. FIG. 4 may be described with continued reference to prior figures, including FIGS. 1-3. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include obtaining, by the processor 248, a trigger signal from the user 108 to move the tailgate 104 from the open position to the closed position.

At step 406, the method 400 may include predicting, by the processor 248, that the electrical cords 116 may contact the tailgate 104 during the tailgate closure operation based on inputs obtained from the vehicle sensor (or the vehicle sensory system 234), responsive to obtaining the trigger signal. At step 408, the method 400 may include performing, by the processor 248, a predetermined action based on the prediction that the electrical cords 116 may contact the tailgate 104 during the tailgate closure operation.

The method 400 may end at step 410.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A vehicle comprising:
an electric outlet located in a vehicle cargo compartment;
a vehicle sensor configured to detect a presence or an absence of an electrical cord interfaced with the electric outlet;
a tailgate configured to move between an open position and a closed position; and
a processor configured to:
obtain a trigger signal from a vehicle operator to move the tailgate from the open position to the closed position;
predict that the electrical cord is expected to contact the tailgate during a tailgate closure operation based on inputs obtained from the vehicle sensor, responsive to obtaining the trigger signal; and
perform a predetermined action based on the prediction, wherein, to perform the predetermined action, the processor is configured to:
determine that the tailgate is moving from the open position to the closed position based on inputs from a vehicle control unit;
monitor one or more electrical components associated with the electric outlet or the electrical cord based on inputs from the vehicle control unit, when the tailgate is moving from the open position to the closed position;
determine a sub-optimal condition associated with one or more electrical components based on the monitoring; and
obtain inputs from a vehicle microphone or sound exciters associated with at least one of sparking, arcing, or distress tones associated with the electric outlet or the electrical cord, when the tailgate is moving from the open position to the closed position.

2. The vehicle of claim 1, wherein the processor obtains the trigger signal when a user manually moves the tailgate from the open position to the closed position.

3. The vehicle of claim 1, wherein, to perform the predetermined action, the processor provides an alert to the vehicle operator via at least one of a user device, a vehicle speaker, a vehicle light, or a vehicle human-machine interface (HMI).

4. The vehicle of claim 1, wherein the processor obtains the trigger signal to activate a tailgate actuator to move the tailgate from the open position to the closed position via at least one of: a user device, a key fob, a predefined user gesture or audio command, or a predefined user movement pattern in proximity to the vehicle.

5. The vehicle of claim 4, wherein, to perform the predetermined action, the processor deactivates the tailgate actuator to prevent movement of the tailgate from the open position to the closed position.

6. The vehicle of claim 4, wherein, to perform the predetermined action, the processor is configured to:
obtain a double trigger signal from the vehicle operator to activate the tailgate actuator to move the tailgate from the open position to the closed position; and
activate the tailgate actuator responsive to obtaining the double trigger signal.

7. (canceled)

8. (canceled)

9. The vehicle of claim 1, wherein the processor is further configured to stop a tailgate movement based on the determination of the sub-optimal condition or based on the inputs obtained from the vehicle microphone or sound exciters.

10. The vehicle of claim 1, wherein the processor is further configured to reverse a movement of the tailgate from a current position to the open position based on the determination of the sub-optimal condition or based on the inputs obtained from the vehicle microphone or sound exciters.

11. The vehicle of claim 1, wherein the processor is further configured to provide an alert to the vehicle operator via at least one of a user device, a vehicle speaker, a vehicle light, or a vehicle human-machine interface (HMI), based on the determination of the sub-optimal condition or based on the inputs obtained from the vehicle microphone or sound exciters.

12. The vehicle of claim 4, wherein, to perform the predetermined action, the processor is configured to:
output a notification to the vehicle operator to confirm the absence of the electrical cord prior to activating the tailgate actuator to move the tailgate from the open position to the closed position;
obtain a confirmation from the vehicle operator responsive to outputting the notification; and
activate the tailgate actuator to move the tailgate from the open position to the closed position responsive to obtaining the confirmation.

13. The vehicle of claim 12, wherein the processor is configured to obtain the confirmation via at least one of: a vehicle human-machine interface (HMI), voice command, or gesture-based input.

14. The vehicle of claim 1, wherein the vehicle sensor is an RGB camera.

15. The vehicle of claim 1, wherein the vehicle sensor is a thermal camera or an infrared camera.

16. The vehicle of claim 1, wherein the processor is further configured to:
determine that the electric outlet is being used or the electric outlet was used less than a threshold time duration in the past based on inputs from a vehicle control unit, responsive to obtaining the trigger signal; and
predict that the electrical cord is expected to contact the tailgate during the tailgate closure operation, responsive to determining that the electric outlet is being used or the electric outlet was used less than the threshold time duration in the past.

17. A method comprising:
obtaining, by a processor, a trigger signal from a vehicle operator to move a tailgate from an open position to a closed position;
predicting, by the processor, that an electrical cord contacts the tailgate during tailgate closure operation based on inputs obtained from a vehicle sensor, responsive to obtaining the trigger signal, wherein the electrical cord is configured to interface with an electric outlet located in a vehicle cargo compartment, and wherein the vehicle sensor is configured to detect a presence or an absence of the electrical cord interfaced with the electric outlet; and
performing, by the processor, a predetermined action based on the prediction, wherein performing the predetermined action comprises:
determining, by the processor, that the tailgate is moving from the open position to the closed position based on inputs from a vehicle control unit;
monitoring, by the processor, one or more electrical components associated with the electric outlet or the electrical cord based on inputs from the vehicle control unit, when the tailgate is moving from the open position to the closed position;
determining, by the processor, a sub-optimal condition associated with one or more electrical components based on the monitoring; and
obtaining, by the processor, inputs from a vehicle microphone or sound exciters associated with at least one of sparking, arcing, or distress tones associated with the electric outlet or the electrical cord, when the tailgate is moving from the open position to the closed position.

18. The method of claim 17, wherein performing the predetermined action comprises providing an alert to the vehicle operator via at least one of a user device, a vehicle speaker, a vehicle light, or a vehicle human-machine interface (HMI).

19. The method of claim 17, wherein performing the predetermined action comprises deactivating a tailgate actuator to prevent movement of the tailgate from the open position to the closed position.

20. A non-transitory computer-readable storage medium having instructions stored thereupon which, when executed by a processor, cause the processor to:
obtain a trigger signal from a vehicle operator to move a tailgate from an open position to a closed position;
predict that an electrical cord contacts the tailgate during tailgate closure operation based on inputs obtained from a vehicle sensor, responsive to obtaining the trigger signal, wherein the electrical cord is configured to interface with an electric outlet located in a vehicle cargo compartment, and wherein the vehicle sensor is configured to detect a presence or an absence of the electrical cord interfaced with the electric outlet; and
perform a predetermined action based on the prediction, wherein performing the predetermined action comprises:
determining that the tailgate is moving from the open position to the closed position based on inputs from a vehicle control unit;
monitoring one or more electrical components associated with the electric outlet or the electrical cord based on inputs from the vehicle control unit, when the tailgate is moving from the open position to the closed position;
determining a sub-optimal condition associated with one or more electrical components based on the monitoring; and
obtaining inputs from a vehicle microphone or sound exciters associated with at least one of sparking, arcing, or distress tones associated with the electric outlet or the electrical cord, when the tailgate is moving from the open position to the closed position.
